(19) United States
(12) Patent Application Publication
(10) Pub. No.: US 2003/0127933 A1
(43) Pub. Date: Jul. 10, 2003

(54) Coil mold piece, manufacturing method thereof, core, manufacturing method thereof, and rotating machine

(76) Inventors: Yuji Enomoto, Kanagawa (JP); Yukinori Taneda, Kanagawa (JP); Noriaki Yamamoto, Kanagawa (JP); Suetaro Shibukawa, Ibaragi (JP); Masaharu Senoh, Chiba (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/364,363

(22) Filed: Feb. 12, 2003

Related U.S. Application Data
(63) Continuation of application No. 09/259,052, filed on Mar. 1, 1999, now abandoned.

(30) Foreign Application Priority Data
Feb. 27, 1998 (JP) 10-047516

(51) Int. Cl. H02K 3/00

(52) U.S. Cl. 310/194; 310/208; 310/254

(57) ABSTRACT

To provide a technology for increasing the utilization rate of the iron core material in the stator of a rotating machine and a technology to improve the space factor of the stator winding in a rotating machine. A stator is formed from a core 2 for a rotating machine comprised of a coreback 22 and a plurality of teeth 21, and a coil mold piece 1 mounted in each of said teeth 21. The coreback 22 and a plurality of teeth 21 are mounted in a separate piece, a link 213 for the teeth 21 is fit onto the corresponding teeth link 221 of the coreback 22 in order to link the coreback 22 and the teeth 21. A coil mold piece is adapted for use in a rotating electric machine, wherein the coil mold piece is compacted-shaped such that a substantial majority of wire windings are plastically deformed to minimize spacings between the wire windings, and such that at least one predetermined cross-section across the coil mold piece has a predetermined wedge shape. The wire material of the coil mold piece 1 contains through holes 1a and is formed while wound in a ring shape. The through holes 1a has a cross-sectional shape to allow fitting onto the teeth.

### FIELD

This invention relates to rotating machinery having a coil mounted on a core, and in particular relates to attainment of high density windings to maintain the coil dimensional shape, a coil mold piece, and manufacturing method thereof, as well as a rotating machine utilizing the same.

### BACKGROUND

Rotating machines such as induction motors, synchronized motors, direct current motors, induction generators, synchronized generators and direct current generators have a stator and rotor as a basic structure. The stator is comprised of a coil and core. The coils are mounted in numerous slots in the core.

The manufacturing method for the stator in small motors is generally known as an insert method. For instance, Japanese Patent Laid-Open No. 9-135555 discloses a coil wound in a pre-specified pattern and set in a coil guide called a braid. The coil guide is then inserted into the core slot by a press-fit jig called a stripper utilizing hydraulic fluid, etc. In order to electrically insulate the space between the coil and the core, in addition to the wire film material, a slot paper insulating material is placed beforehand in the coil slot and the insertion method is then used to insert this arrangement into the coil. Also, the winding, is wound onto the core with a winding method referred to as coil pitch winding, and is wound in a configuration spanning a plurality of slot teeth on the core.

In contrast, another winding method is called pole pitch winding. In the pole pitch winding method, one coil is wound on one tooth. In the pole pitch winding method, a direct winding method to directly wind wire from the internal circumference of the core is utilized and a stator core is split as revealed in Japanese Patent Laid-Open No. 6-105487. Wire is wound on these split cores one by one, the wire-wound core pieces are joined by welding, and then the components are assembled together in one commonly used method.

However, the technology of the background art has the following problems. A first problem is that in the coil inserter method, the wire-wound coil is inserted utilizing the slot clearance, so that when the stator coil wound with the wire is inserted, the space factor (rate of wire material cross-sectional area versus the core slot cross-sectional area) is not large enough. The current limit on the space factor for such method is about 60 to 65 percent. A second problem is that in the pole pitch winding method and the direct winding method, the wire material is inserted utilizing the core slot clearance just as with the inserter method, so that the space factor is still not very high (about 60 percent). Further, even in the method where the coil is split and then wound with wire, the space factor is still not high enough due to the dimensions involved after accounting for factors such as clearance during core assembly, wiring wind deviations between wire material and interference between adjacent coils, etc. A third problem is that in both the pole pitch winding method and the direct winding methods, the material utilization rate is a low 30 to 40 percent when obtaining a round stator core from rectangular material. Currently, this usage rate only increases to about 50 to 60 percent even when splitting the coil and trimming the plate arrangements are taken into account.

### SUMMARY

A coil mold piece adapted for use in a rotating electric machine, wherein the coil mold piece is compacted-shaped such that a substantial majority of wire windings are plastically deformed to minimize spacings between the wire windings, and such that at least one predetermined cross-section across the coil mold piece has a predetermined wedge shape.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure hereof this invention. While the foregoing and following written and illustrated disclosure focuses on disclosing example embodiments of the invention, it should be clearly understood that the same is by way of illustration and example only and is not to be taken by way of limitation, the spirit and scope of the present invention being limited only by the terms of the appended claims.

The following represents brief descriptions of the drawings, wherein:

FIG. 1 is a fragmentary oblique view of a background structure of a motor conforming to this invention;

FIG. 2 is an oblique view of an example structure for the stator of a motor conforming to this invention;

FIG. 3 is an oblique view showing an example coil mold piece of this invention;

FIG. 4 is a plan view showing an example unloaded core embodiment of this invention;

FIG. 5 is a plan view illustrating an example loaded core embodiment, including an example mounting position of example coil mold pieces onto the core of this invention;

FIG. 6 is a cross-sectional view showing an enlarged view of an example mounting position of an example coil mold piece onto the teeth of this invention;

FIG. 7 is a cross-sectional drawing showing an example press mold forming an example coil mold piece of this invention;

FIG. 8 is a cross-sectional drawing showing another example press mold prior to forming another example coil mold piece of this invention;

FIG. 9 is a cross-sectional drawing showing the FIG. 8 example press mold after forming the FIG. 8 example coil mold piece of this invention;

FIG. 10 is an example table showing examples of a relation of a load, forming dimensions and pinholes when forming an example coil mold piece of this invention;

FIG. 11 is an example graph showing a relation of the load and forming dimensions when forming an example coil mold piece of this invention;

FIG. 12 is an example drawing comparing a change in cross-sectional area before and after forming of an example coil winding of this invention;

FIG. 13a is an example drawing showing a background coil winding mounted on a tooth, while FIG. 13b is an example drawing showing a cross-section taken along line 13b′-13b″, and FIG. 13c is an example drawing showing a cross-section taken along line 13c′-13c″;

FIG. 13d is an example drawing showing and example winding status mounted on a tooth after an example coil forming in the method of this invention, while FIG. 13e is a cross-sectional view taken along line 13d′-13d″;

FIG. 14a is an example plan view showing example teeth strips formed from metal stock, while FIG. 14b is an example plan view showing an example coreback strip formed from metal stock;

FIG. 15a is an example oblique view showing insertion of an example coil mold piece onto an example teeth assembly, and insertion of the example teeth assembly into an example coreback; FIG. 15b is an example plan view showing insertion of an example coil mold piece onto the example teeth assembly; and FIG. 15c is an example plan view of an example teeth assembly fully loaded with example coil mold pieces;

FIGS. 16a-16g are example plan views of example alternative arrangements for joining teeth to a coreback, in accordance with embodiment of the present invention;

FIG. 17 is an example plan view of example nonjoined teeth inserted into an example coreback;

FIGS. 18a-18b are example plan views of an example two-sector coreback strip, and an example core constructed utilizing the same;

FIG. 19 includes example plan and oblique views of an example protective sleeve being provided on an outside of an example core, and compression being applied thereto;

FIG. 20 includes example oblique views of an example protective wrap in various stages of application to the outside of an example core;

FIG. 21 includes example plan and oblique views of an example core constructed using example single-sector coreback strips;

FIG. 22 includes example cross-sectional and oblique views of further example processes/arrangements being applied to the example core of FIG. 21;

FIGS. 23a-23e are example plan views of example two-sector coreback strips having various example groove or indentation arrangements, while FIG. 23f is an example plan view of an example three-sector coreback strip;

FIG. 24a includes example plan and oblique views of an example two-sector coreback strip and an example coreback constructed using such two-sector coreback strips in a mis-aligned, overlapping manner, while FIG. 24b includes example plan and oblique views of an example two-sector coreback blocks and an example coreback constructed using such two-sector coreback blocks in a mis-aligned, overlapping manner;

FIGS. 25a-25c show example plan views of a portion of a core constructed using various example two-sector coreback strips;

FIGS. 26a-26c show example plan views of example alternative link/groove arrangements, and also example accommodation splits 260;

FIGS. 27a-17b show example plan and cross-sectional views of various two-sector coreback strips arranged in a mis-aligned manner from layer-to-layer, and including various accommodation splits and alignment/attachment arrangements;

FIG. 27c shows example plan and edge views of an example embodiment wherein example links 213 are of a reduced thickness in comparison to a remainder of the teeth from which the links 213 extend; and

FIG. 28 shows oblique views of an example laminated tooth of a predetermined height, and an example laminated coreback for a predetermined height.

### DETAILED DESCRIPTION

Before beginning a detailed description of the subject invention, mention of the following is in order. When appropriate, like reference numerals and characters are used to designate identical, corresponding or similar components in differing Fig. drawings. Further, in the detailed description to follow, exemplary sizes/models/values/ranges may be given, although the present invention is not limited to the same. As a final note, well known power connections to and between components are not all shown within the FIGS. for simplicity of illustration and discussion, and so as not to obscure the invention.

Hereafter, example embodiments of this invention are explained while referring to the accompanying drawings, utilizing motors such as an induction motor and synchronous motor as examples. This invention, however, is not limited to these examples or these types of rotating machinery, e.g., many differing embodiments of the present invention may be practiced with many different types of rotating machinery, including generators.

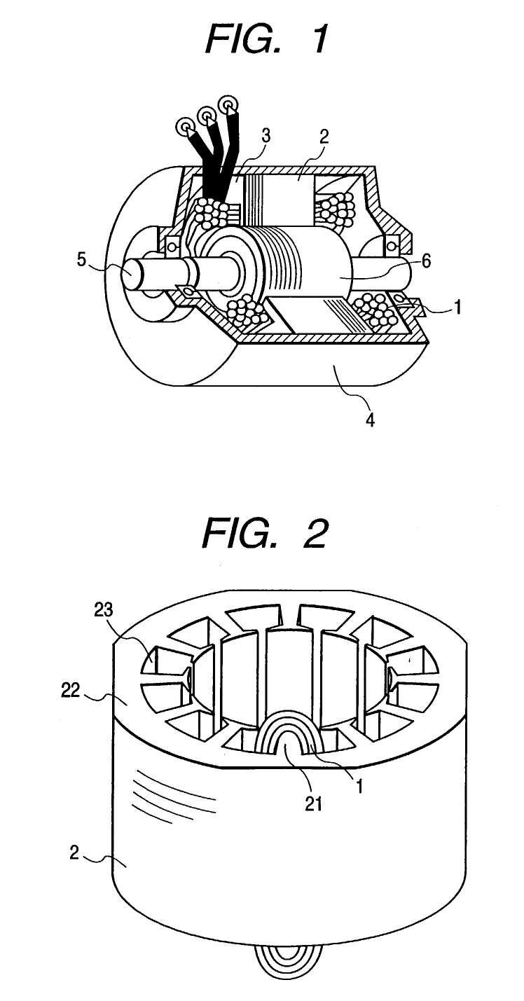

Induction motors and synchronous motors may have a basic structure as shown in FIG. 1, with casing 4 holding a stator 3 and a rotor 6 provided on a shaft 5. The stator 3 may include a core 2 and a coil 1. In this invention coil mold pieces may be utilized to construct the coil 1. As shown in FIG. 2, the core 2 may include a coreback 22 having teeth 21 protruding into an inner circumferential side of the coreback 22. In the inner circumferential side of the core 2, any space enclosed by the teeth 21 may define a slot 23. Coil mold pieces 1 may be mounted on the teeth 21 and inserted in the slots 23. In this invention, the coil mold piece 1 and the core 2 each have a new configuration. Further, a new configuration has been contrived for the stator assembly method (discussed ahead) using a coil mold piece 1 and the core 2.

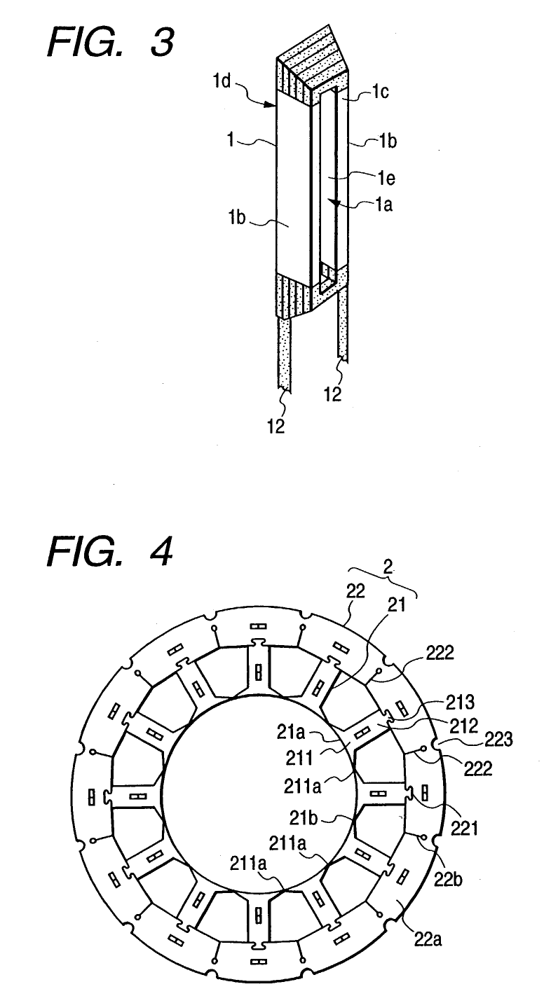

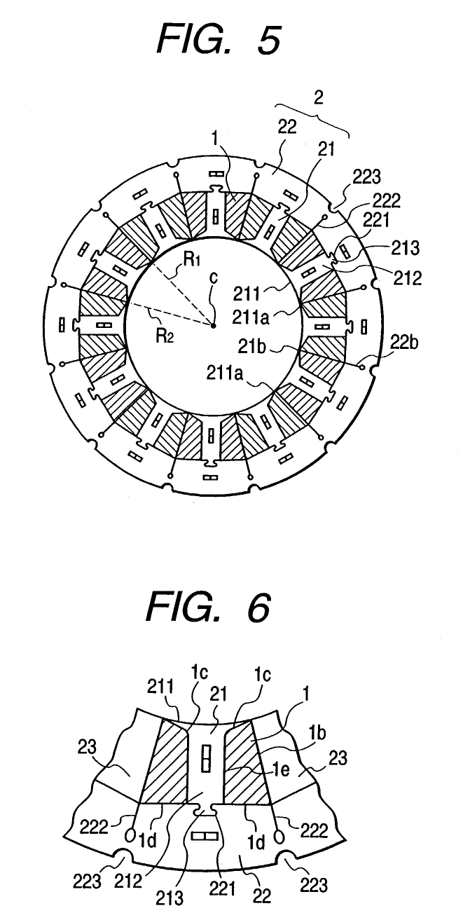

The coil mold piece 1 as shown in FIG. 3, may be formed from being wire-wound in a ring-like coil loop shape so as to include a through hole 1a. Such through hole 1a may further be formed in a suitable cross-sectional shape/size capable of engaging with the teeth 21. The sides 1b of the coil mold piece 1 may be of a substantially flat plane which, if extended sufficiently, would substantially intersect a center (see FIG. 5's center C and radii R₁ and R₂) of the rotating machinery into which it is installed, and may abut against similarly flat plane sides of neighboring coil mold pieces so as to minimize an amount of unoccupied space between the coil mold pieces, thus enhancing a space density and efficiency of the rotating machinery. Front sides 1c of the coil mold piece facing inwardly toward a center of the rotating machinery may have a surface shape which closely matches surface shapes of teeth 21 upon which it abuts, i.e., to maximize a space density and make efficient use of the space between the coil mold piece 1 and the teeth 21. A back side 1d of the coil mold piece has a surface shape which closely matches a surface shape of a core 2 area upon which it abuts, i.e., to maximize a space density and make efficient use of the space of the slot 23.

The inner circumferential portions of the coil mold piece 1 which define the through holes 1a may have parallel sides 1e in order that both edges of the coil insertion portion for the teeth 21 can be formed in parallel, i.e., to closely match abutting surface shapes between the sides 1e and teeth 21, and make efficient use of the space therebetween.. Use of parallel sides 1e and teeth 21 has the advantage of allowing easy insertion of the coil mold piece onto the teeth 21. In contrast, when the teeth 21 have a different shape, the shape of the cross-section and abutting surfaces of the through holes 1a must also be correspondingly changed. The coil mold piece 1 may have leader lines 12 in order to allow electrical connections to be made.

Further, as shown most clearly by the cross-hatched portion of FIG. 6, the coil mold piece 1 may have a generally have a hollowed fan-like (or wedge-like, pie-like, triangular-like) cross-section, wherein the side surface of the portion stored in a slot 23 spreads out in a fan shape in a direction from one end of the through hole 1a to the other end of the through hole 1a. In such a case with a spreading fan shape, when the coil mold piece 1 is situated in the slot 23, the sides of the fan-like shape may be defined by two predetermined diameters R₁ and R₂ (FIG. 5) extending substantially from the rotating machinery's center C and drawn through the center of each slot 23. In this way, coil mold pieces can be delimited to specific fan-shaped areas, such that many more windings can be stored in a more densely compacted fashion. Further, excessive interference from adjacent coil mold pieces 1 can be avoided, i.e., excessive contact between neighboring coil mold pieces 1 can be avoided when assembling the stator and/or during any working vibration of the coils, such that the occurrence of problems such as scratches, damage and insulation defects due to direct contact and friction between adjacent coil mold pieces can be prevented.

The wire material comprising the coil mold pieces 1 may be made from metallic wire, and may be covered by an insulating sheath over a surface of the metallic wire. Copper may be generally utilized as the material of the metallic wire, while the insulating sheath may, for instance, utilize polyester amide. In this example embodiment of this invention, PEW (polyester amide) is utilized.

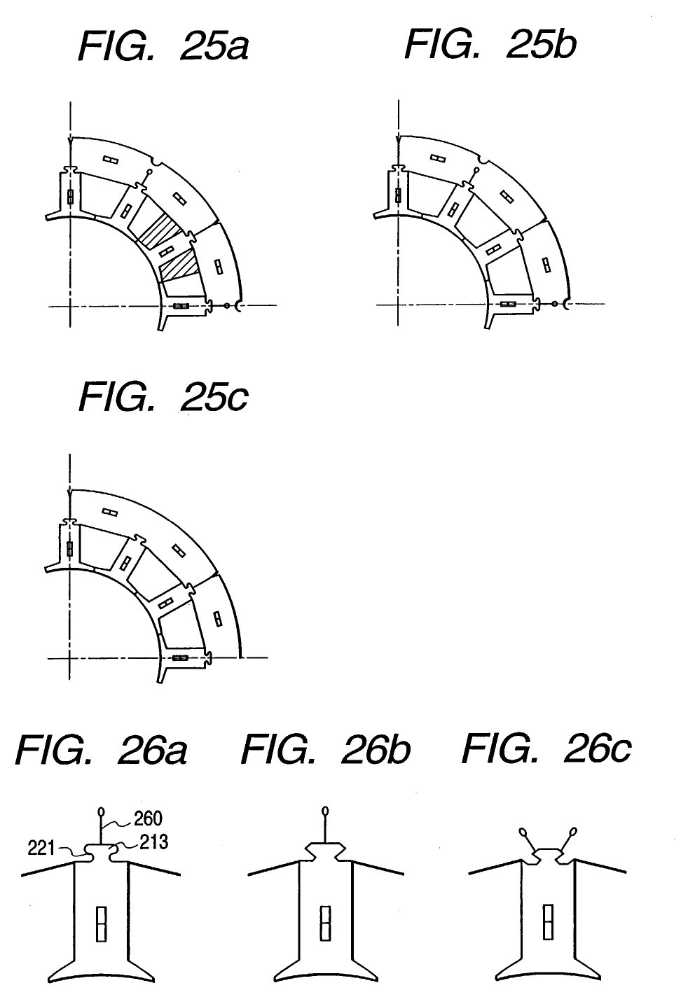

Also, in this example embodiment as shown most clearly in FIG. 6, one end of the coil mold piece 1 (representing a narrower side of fan shape) forms the end surface 1c abutting against a teeth tip 211, while an opposite end surface (representing a wider side of the fan shape) forms an end surface 1d abutting against the coreback 22 side. Here, the end side 1c positioned at teeth tip 211 may have an oblique shape retracting towards the inner circumferential side 1e. This shape takes into account and may closely match the slope on the rear side of the teeth tip 211 of the teeth 21. Of course, the end 1c need not always utilize this sloped shape, but may utilize different shapes to match varying shapes of the teeth 21. For example, FIGS. 25a-25c show arrangements wherein the teeth have straight shapes for a surface abutting ends 1c of the coil mold pieces.

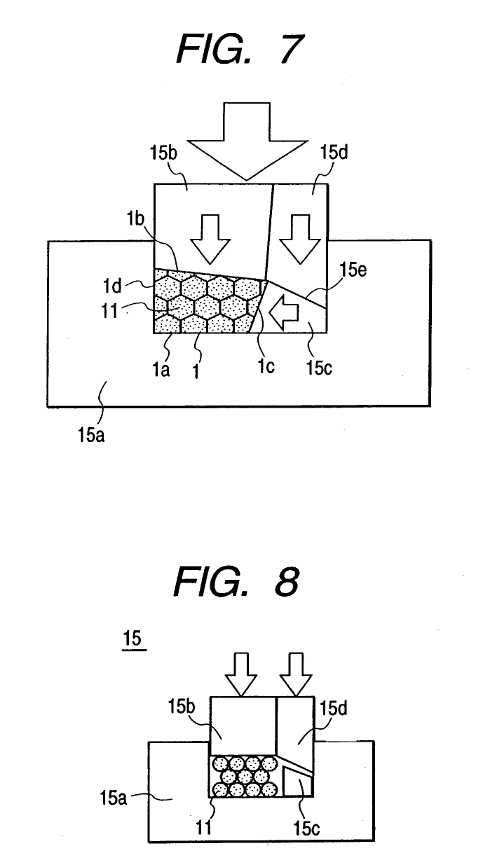

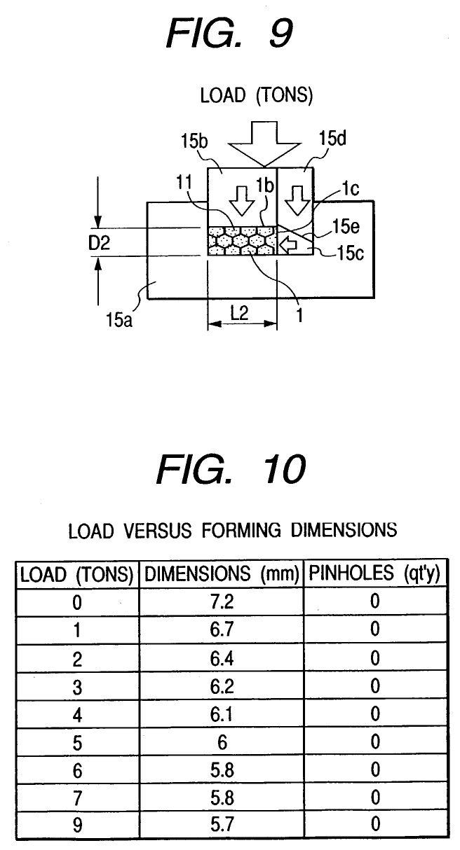

Hereafter, formation of example coil mold pieces having differing shapes will be described while reference to FIG. 7 and FIGS. 8-9. More particularly, discussion turns first to FIGS. 8-9 which show formation of example coil mold pieces of a simpler shape. More particularly, the FIGS. 8-9 coil mold piece 1 is described without the side surfaces 1b and 1c having a tilt, in order to simplify the explanation. While the coil mold pieces will be described as being compacted-shaped using a press, practice of embodiments of the present invention are not limited thereto, e.g., coil mold pieces could just as easily be compacted-shaped using other forms of compacting machinery such as a stamper.

Shown in FIG. 8 is cross-section of a press mold arrangement 15 having a bobbin 15a upon which wire material 11 is wound in a coil-like shape, and press mold pieces 15b, 15c and 15d. It should be noted that the FIGS. 7-9 represent press mold arrangements which press mold only a portion of the coil mold piece 1 during each press mold operation. To treat further portions of the coil mold piece 1, such portions may be simply repositioned within the press mold arrangement, or the FIGS. 7-9 press mold arrangements may be extended and/or mirrored to treat the entire coil mold piece 1 in a single operation. The purpose of the press mold pieces 15b, 15c and 15d is to apply pressure to the coil of wire material 11 wound on the bobbin 15a. A pressurizing device (not shown) as well as a control device (not shown) to control the timings and pressure being applied by the press mold pieces 15b, 15c and 15d are utilized. Pneumatic pressure or hydraulic pressure may, for instance, be utilized as the pressure source. As but one example, 40 turns of 1.2 mm diameter wire may be wrapped around the bobbin 15a, so as to form a coil loop.

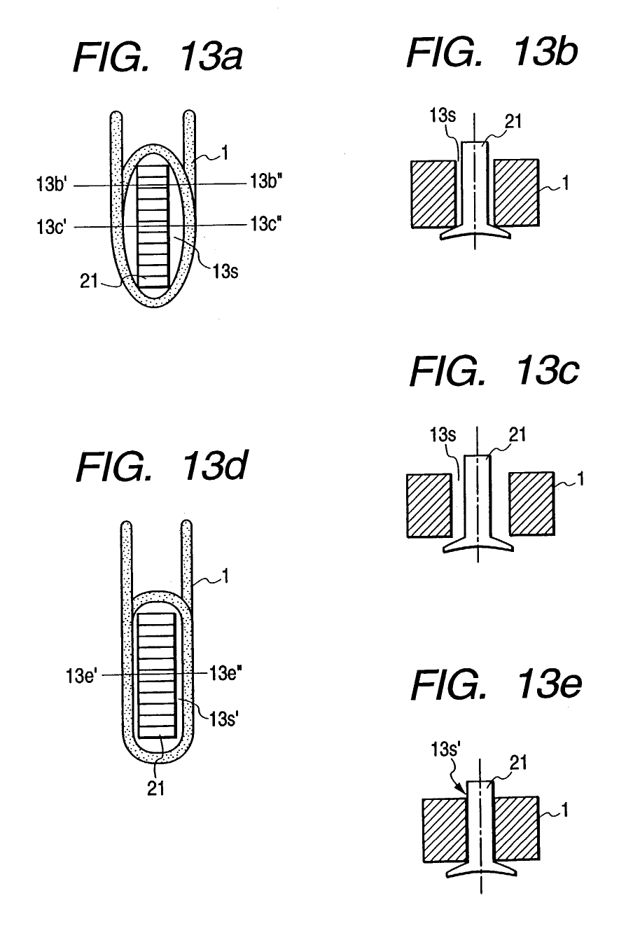

Before pressure is applied, the coil of wire material 11 generally has a loose wire group cross-section as shown in the left-hand FIG. 12 cross-sectional diagram, and a generally loosely rounded oval-shaped coil loop shape as shown in the FIG. 13a diagram. As can clearly be seen in the left-hand FIG. 12 diagram, the wire group at this stage, has loosely-packed wires of individual round shapes with spaces therebetween, such that a packing density of such wire group is disadvantageously low (see formulas in FIG. 12). Also, as can clearly be seen in the FIG. 13a diagram, the generally loosely rounded oval-shaped coil loop disadvantageously has wasted space 13s between the tooth 21 and the coil, and a size of such space 13s is substantially inconsistent in that it varies along the longitudinal length of the tooth 21, i.e., has a disadvantageous low and variable packing density. More particularly, FIG. 13b shows a cross-sectional view taken along FIG. 13a's line 13b′-13b″, with an inter-component space 13s of a smaller size, while FIG. 13c shows a cross-sectional view taken along FIG. 13a's line 13c′-13c″, with an inter-component space 13s of a larger size. Such a condition, if left unchanged, could result in a small space density for this gap when assembling the coil as a motor stator, and thus cause poor rotating machinery efficiency/performance.

Turning now to further discussion of a press molding operation, the hollowed arrows in FIG. 8 are illustrative of forces beginning to be applied to the press mold pieces 15b and 15d to start to apply pressure to the coil of wire material 11 wound on the bobbin 15a. Interaction between the mating slanted or oblique surfaces 15e of the press mold pieces 15c and 15d causes the press mold piece 15c to move into contact with the wire group as shown in FIG. 9. More particularly, the press mold piece 15b applies pressure to one side surface of coil winding 11 group, i.e., to the side becoming side surface 1b of the coil mold piece 1. Cooperation of press mold pieces 15c and 15d apply pressure to another side surface of the coil winding 11 group, i.e., to the portion forming side surface 1c of the coil mold piece 1. In this case, the press mold piece 15c presses in a cross (e.g., approximately perpendicular) direction to that of press mold piece 15b. The bottom of the press mold piece 15d and the top of the press mold piece 15c therefore make contact diagonally. This arrangement allows a partial pressure to be obtained at intersecting directions from the pressure of press mold piece 15d by way of the oblique surface 15e, and press mold piece 15c to apply pressure in a lateral direction. This arrangement has the advantage that a joint pressure source can be used to apply pressure to both the press mold pieces 15b and 15d from the same direction.

An additional load force (indicated by the FIG. 9 largest hollowed arrow) of several predetermined tons may be continued to be applied so as to cause permanent plastic deformation of parts of the coil, and at least the following may be changed into predetermined shapes/sizes as determined by the design of the press mold 15 and the load forces: the cross-sectional shape of the individual wires; the packing density of the wire group; the overall cross-sectional dimensions of the wire group; and, the overall shape of the coil loop. For example, as shown in FIG. 9, the wire group may now have compressed dimensions such as a length L2 and a width D2. Once the load force is ended, and the coil 1 removed from the press mold 15, the coil retains its deformed but advantageous shapes/sizes owing to the permanent plastic deformation of the wires. Furthermore, since the coil mold piece 1 maintains a fixed state, no special jig is required to prevent the coil from unraveling or being disturbed during the mounting.

More particularly, in explaining such advantageous shapes/sizes, the coil of wire material 11 may now generally have a wire group cross-section as shown in the right-hand FIG. 12 cross-sectional diagram, and further may have a generally rounded rectangular-shaped coil loop as shown in the FIG. 13d diagram. As can clearly be seen in the right-hand FIG. 12 diagram, the wire group at this stage may have more densely-compacted wires being of deformed individual (e.g., hexagonal) shapes, such that a packing density of such wire group is advantageously higher (see formulas in FIG. 12). Also, as can clearly be seen in the FIG. 13d diagram, the deformation may cause a generally rounded rectangular-shaped coil loop which advantageously minimizes or eliminates wasted space 13s′ between the tooth 21 and the coil, and further, may cause a size of such space 13s to be substantially consistent along the longitudinal length of the tooth 21, i.e., has an advantageous higher and more consistent packing density. More particularly, FIG. 13e shows a cross-sectional view taken along FIG. 13d's line 13e′-13e″, with an inter-component space 13s′ of a minimized size. Thus, an improved space factor can be obtained when a structure such as shown in FIG. 13e is utilized. Further, not only are the sides of the coil compressed, but the cross-section of the slot insertion section can be formed in the shape as shown in FIG. 6, to match one half of the internal shape of the slot 23.

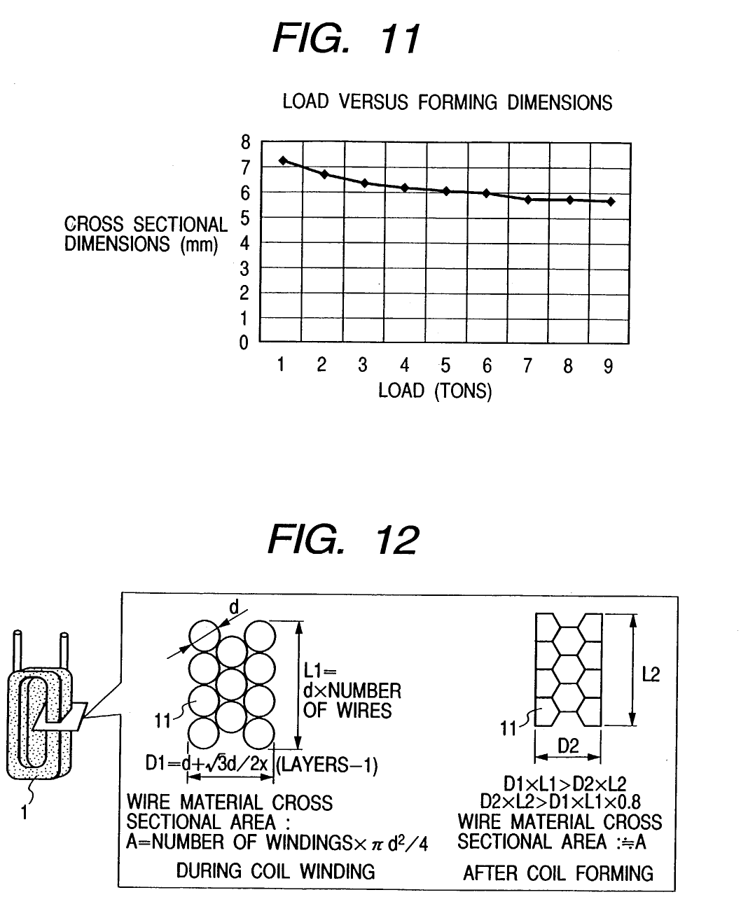

An overview concerning features/changes in the shape of the coil mold piece is next described, while referring to FIG. 10, FIG. 11 and FIG. 12. The coil cross-section dimensions while wire material 11 is in a non-deformed wound state, and the cross-section dimensions of the coil mold piece 1 after press mold deformation, are obviously different as can be seen in FIG. 12. In other words, when the diameter of the wire material 11 is set as d, the dimension D1 for the horizontal direction on the work drawing may be {d+\sqrt{3}·d/2 ·(number of wiring layers−1)} and the dimension L1 in the vertical direction may be (d·(the number of wires in line along L1 dimension)). The coil cross-sectional surface area may be (D1·L1). Accordingly, cross-sectional dimensions in a wire-wound state smaller than this cross-sectional area cannot be geometrically obtained (without deformation).

In this invention, after winding the wire, the coil cross-sectional area after press mold deformation becomes smaller than in the original wound state, i.e., due to application of forming pressure at the slot insertion section of the coil. Stated differently, if the cross-sectional area of the wire material itself is assumed uniform, then the coil cross-sectional area (D2·L2) after deformation forming will be smaller than the cross-sectional area (D1·L1) after the original (i.e., non-press molded) wire winding. As one example, if the cross-sectional area of the wire material itself becomes smaller due to compression, then the cross-sectional area (D2·L2) for the entire coil cross-section may become approximately 80 percent of the original dimensions.

In other words, a coil mold piece 1 wherein, with the diameter of the wire material as d, the windings aligned radially along the core as m, the number of wire layers aligned tangentially across the core as n, and with the wire material well aligned in the slot, the surface area Sₒ for a particular cross-section may be expressed as:

S₀={d+\sqrt{3}·d/2·(n−1)}·(d·m)

so that the cross-sectional area Sₚ for the portion stored in said slot for a cross-section of the same section may be Sₚ<S₀.

FIG. 10 has columns which show a numeric relation between the cross-sectional dimension D2 (illustrated in the center column) and the load (illustrated in the left-hand column) during press mold forming. FIG. 11, in turn, shows a graphical representation of such information. The cross-section dimension become smaller when the pressure during forming is increased as shown in FIG. 10 and FIG. 11. However, eventually a deformation limitation is reached, and no significant changed occurs beyond a load of a certain level such as 6 tons.

During the forming, the insulation material (not shown in drawing) of each wire may itself be deformed along with the wires. However, as evidenced by the numerical pinhole data (illustrated in the right-hand column) in FIG. 10, there is no disadvantageous destruction of the wire insulating material according to the tests performed by the inventors. The pinhole count shown in FIG. 10 signifies the number of torn spots in the insulation film of the wire material. More particularly, in order to test for such torn spots, normally, while the electrical line is immersed in electrolytic solution, a check is made to investigate from how many locations have electrical leakage occurring. The results of the check are shown by the number of pinholes. In this embodiment, the number of pinhole leaks is zero even if the load is increased in the range shown in FIG. 10. Accordingly, this result advantageously shows that there was no damage to the electrical wiring insulation due to the press mold forming process.

In returning discussion back to FIG. 7, while the FIGS. 8-9 embodiment discloses a coil mold piece of a simpler shape with a non-slanted sides 1b and 1c, the FIG. 7 embodiment discloses a coil mold piece having slanted sides 1b and 1c. FIG. 7 shows a cross-sectional view wherein the material has already been compressed, advantageously resulting in a coil mold piece of the aforementioned fan-like shape because of the slanted sides 1b and 1c. Accordingly, FIGS. 7, 8 and 9 are examples wherein it can be seen that the press mold components can be designed/selected to provide differing shapes of the coil mold piece to be formed.

One example laminated core (including teeth) embodiment will next be described while referring to FIGS. 4-6, 14a-14b and 15a. A cross-sectional view of a desired example core arrangement while the coil mold pieces are not mounted is shown in FIG. 4, whereas a cross-sectional view of the example core arrangement while the coil mold pieces are mounted is shown in FIG. 5. Use of lamination of the core is advantageous in minimizing eddy current losses within the rotating machinery, especially if an insulation layer (not shown) is provided between lamination layers and of arrangements used to interconnect the lamination layers.

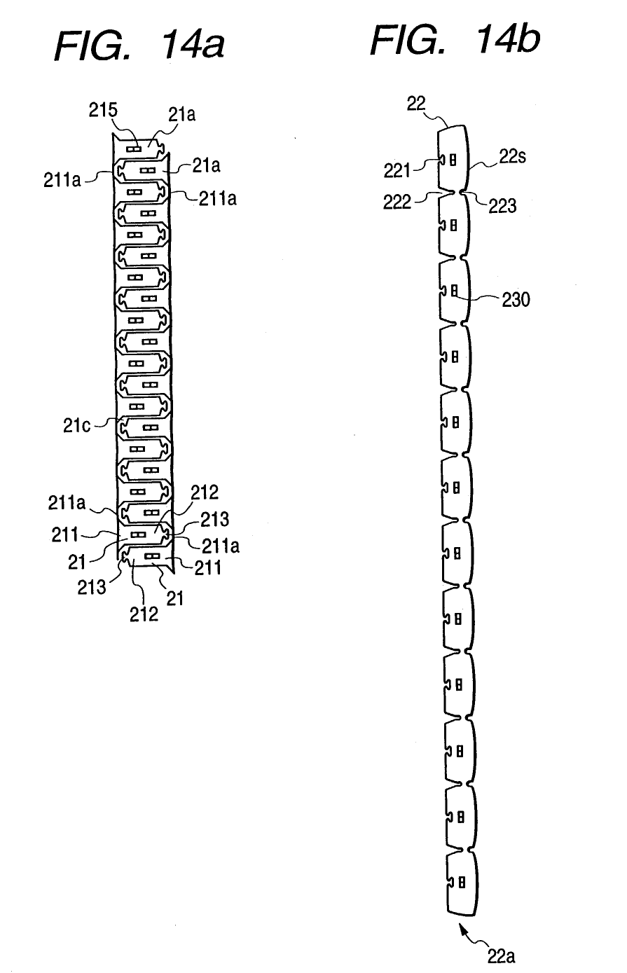

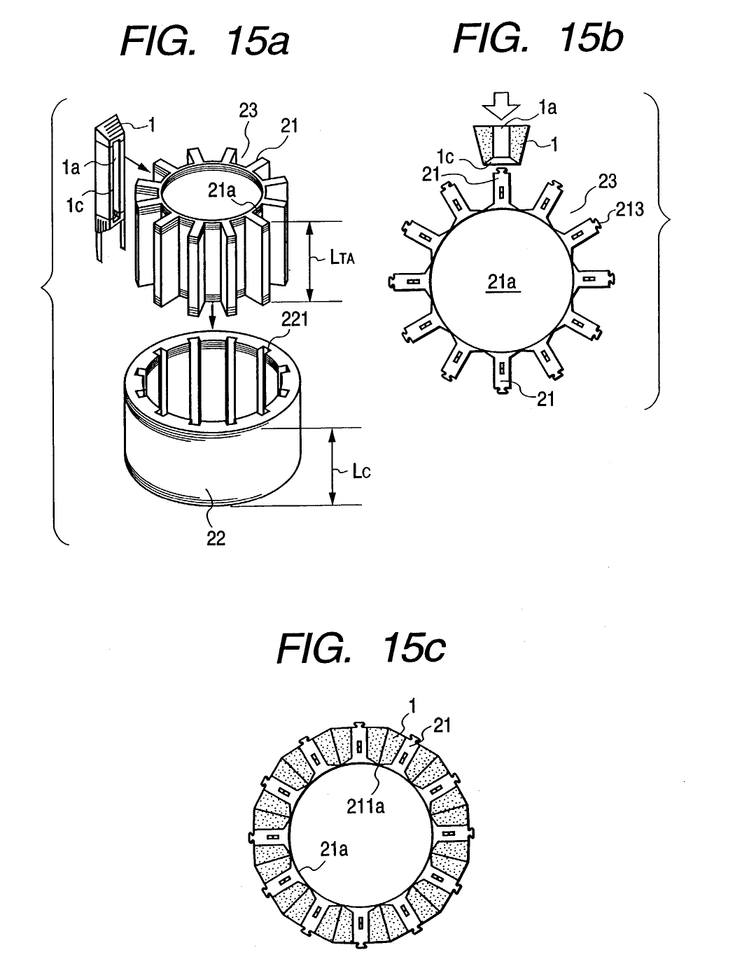

Turning now to further specifics, the core may be constructed of a laminated coreback 22 and laminated teeth assembly 21 as shown in FIG. 15a. More particularly, each tooth 21 may have a rough T shape. Further, in detailing an example construction, FIG. 14a shows one example where two teeth strips 21a may be stamped from a metal strip or tape. The manufacturing of these members need not be limited to stamping, but instead other methods (e.g., laser cutting) may be utilized. By forming two opposing and interleaved teeth strips 21a from a single metal strip or tape as shown, metal strip material can be efficiently used with little wastage of material. In this embodiment, as can be seen from FIG. 14a, the wasted portion may be mainly the two sets of cutaway pieces 21c. Here, by trimming this cutaway 21c as diligently as possible, the material utilization rate of about 81 percent of the metal strip can be obtained.

In each tooth 21, there is a tooth main body 212, and also a widened tooth portion or tip 211a of the tip 211 of each tooth 21 acts as an interconnection or bridge connected with a widened tooth portion or tip 211a of an adjacent tooth 21. With this type of connected structure, the teeth 21 are handled as one integrated structure so that handling may be easy and convenient during manufacture and assembly. Another advantage is that the structural strength is increased as neighboring teeth 21 are integrally interconnected. Further, such tip 211a interconnections or bridges acts as a localized area which absorbs the deformations and stresses involved with deforming the teeth 21 strips into a rounded loop structure. Further, a portion of a space between adjacent teeth main bodies 212 may be utilized for absorbing the contraction of the member when bent into a ring shape.

In addition to the interconnections or bridges, each tooth may be provided with a link 213 in order to connect to the coreback 22. As will become more apparent in the discussions to follow, the link or tongue 213 mates with a teeth link groove 221 provided within a coreback laminate sector 22s. Further, the mating link 213/teeth link groove 221 may be of many differing configurations as discussed ahead.

The teeth strips 21a may each be formed to have a predetermined length, e.g., to have twelve teeth 21 interconnected at the tips thereof, and the predetermined length may thereafter be deformed such that ends thereof are abutted against each other to form a joint 21b, i.e., where the length becomes a looped or circular teeth pattern as shown in FIG. 4. A predetermined plurality of such looped teeth strips 21a can be laminated one on top of each other so as to form a teeth assembly (e.g., teethed core portion) 21 of a predetermined thickness Lₜₐ (FIG. 15a).

Further, when the teeth strips 21a are deformed into a circular teeth pattern, a joint 21b (FIG. 4) occurs where the two ends of the teeth strips 21a meet each other in mutual contact. Such ends may be fastened to each other for instance by caulking or welding. If fastened by caulking, silicon steel plate for instance can be deformed by plasticizing to make contact between the ends. Regarding joint placement within the teeth assembly 21, as one embodiment, the joint for different layers may be provided at the same circumferential location from laminate layer to laminate layer, so as to provide a commonly located joint (forming a groove) along the length of the teethed core portion. As another embodiment, the joint can be provided at a differing locations from laminate layer to laminate layer, such distributed joint embodiment being advantageous in providing improved teeth assembly 21 strength. Further, as an alternative embodiment, the teeth strip 21a may be formed as a continuous strip, wherein the continuous strip may be spirally deformed into a circular pattern so that a laminated teethed core portion 21 may be formed as a spiral laminate.

As further discussion regarding the teeth, each tooth 21 may have an alignment/attachment zone 215, so as to provide alignment and/or attachment of overlapping teeth layers when respective laminate tooth layers are overlapped. Appropriate arrangements/procedures may be provided with respect to such overlapping alignment/attachment zones 215 to cause the laminated tooth layers to become aligned and/or permanently attached to one another. For example, such alignment/attachment zones may be of such a design/arrangement that overlapping layers mate and/or interlock with each other. As another example, spot welding can be applied to the alignment/attachment zones to weld the overlapping layers together. Still further, the alignment/attachment zones 215 may be a through-hole for allowing the overlapping layers to be interlocked using a rivet or bolt pushed therethrough. As another example, the attachment zones 215 may be caulked to interlock together.

Turning now to discussion of the coreback 22, FIG. 14b shows one example where a coreback strip 22a may be stamped from a metal strip or tape, so as to include a plurality of coreback sectors 22s. Again, the manufacturing of these members need not be limited to stamping, but instead other methods (e.g., laser cutting) may be utilized. By forming such coreback strip 22a from a single metal strip or tape as shown, metal strip material can be efficiently used with little wastage. More particularly, in the case of the coreback strip 22a, the shape has little waste so that, for instance, a material utilization rate of approximately 85 percent can be obtained. Accordingly, in averaging using the FIG. 14a-14b embodiment, a material utilization rate of about 80 percent or more can be obtained for both the teeth and the coreback. This means that a large improvement in material utilization rate can be obtained compared with the background arrangements.

In each coreback strip 22a, notches 222 may be included between adjacent coreback sectors, for absorbing the contraction of the member when bent into a ring shape. Likewise, on the outer circumferential side of the coreback strip 22a, notches may be provided to absorb the expansion and contraction of the member on the outer circumferential surface when the member is bent into a ring shape. The notches may be formed by any combination of stamping or cutting of the metal. Further, tabs 223 may be included to act as interconnections or bridges interconnecting adjacent coreback sectors. With this type of connected structure, the coreback strip 22a including all the coreback sectors 22s may be handled as one integrated structure, so that handling may be easy and convenient during manufacture and assembly. Another advantage is that the structural strength may be increased as neighboring coreback sectors 22s are integrally interconnected. Further, the tab 223 interconnections or bridges acts as localized areas which may absorb the deformations and stresses involved with deforming the coreback strip 22a into a rounded loop structure.

In addition to the tab 223 interconnections or bridges, each coreback sector may be provided with a teeth link groove 221 to receive a link 213 in order to connect to the teeth 21. The coreback strips 22a may each be formed to have a predetermined length, e.g., to have twelve coreback sectors interconnected by the tabs 223. More particularly, the coreback strips 22a may have a number of coreback sectors so as to match a number of teeth 21 of the teeth strip 21a, as shown in FIG. 14b. The predetermined length may thereafter be deformed such that ends thereof may be abutted against each other to form a joint 22b, i.e., where the length becomes a looped or circular coreback layer as shown in FIG. 4. A predetermined plurality of such looped coreback strips 22a can be laminated one on top of each other so as to form a coreback assembly 22 of a predetermined thickness L_{c} (FIG. 15a).

Further, when the coreback strips 22a are deformed into a circular coreback pattern, a joint 22b (FIG. 4) occurs where the two ends of the coreback strips 22a meet each other in mutual contact. Such ends may be fastened to each other for instance by caulking or welding. If fastened by caulking, silicon steel plate for instance can be deformed by plasticizing to make contact between the ends. Regarding joint placement within the coreback 22, as one embodiment, the joint for different layers may be provided at the same circumferential location from laminate layer to laminate layer, so as to provide a commonly located joint (forming a groove) along the length of the coreback 22. As another embodiment, the joint may be provided at a differing locations from laminate layer to laminate layer, such distributed joint embodiment being advantageous in having improved coreback 22 strength. Further, as an alternative embodiment, the coreback strip 22a may be formed as a continuous strip, wherein the continuous strip may be spirally deformed into a circular pattern so that a laminated coreback 22 may be formed as a spiral laminate.

As further discussion regarding the coreback sectors, sectors may have an alignment/attachment zone 230, and when respective laminate coreback sectors are overlapped, alignment/attachment zones 230 of overlapping coreback sectors 22s may be used to align with one another. Further, appropriate arrangements/procedures may be provided with respect to such overlapping alignment/attachment zones 230 to cause the laminated coreback sectors to become permanently attached to one another. For example, such alignment/attachment zones may be of such a design/arrangement that overlapping layers mate and interlock with each other. As another example, spot welding can be applied to the alignment/attachment zones to weld the overlapping layers together. Still further, the alignment/attachment zones 230 may be a through-hole for allowing all the overlapping layers to be interlocked using a rivet or bolt inserted therethrough. As another example, the alignment/attachment zones 230 may be caulked (i.e., plastically deformed) to interlock together.

Next, there will be described one example method of using the manufactured coil mold pieces 1, teeth assembly 21 and coreback 22 to assemble a stator. More particularly, FIG. 15a shows a state where a predetermined plurality of layers have been laminated to form each of the teeth assembly 21 and coreback 22 of predetermined thicknesses. Also shown in FIG. 15a and also in the cross-sectional view of FIG. 15b, is the insertion (i.e., loading) of a coil mold piece 1 onto the teeth of the teeth assembly 21. A sufficient number of coil mold pieces 1 are inserted onto the teeth until a fully-loaded teeth assembly 21 such as shown in FIG. 15c is obtained. The links or tongues 213 of the teeth assembly 21 may be aligned with the teeth link grooves 221 of the coreback 22 so as facilitate mating of the same, and suitable pressure (e.g., via a press) may be used (e.g., see FIG. 15a) to press the full-loaded teethed core portion 21 assembly into the coreback 22. The result is the stator arrangement shown by the FIG. 5 cross-sectional view. Perspective views of such stator arrangement may also be seen in FIGS. 19 and 20, which are used to illustrate yet another optional assembly step.

More particularly, once the stator arrangement is assembled as discussed above, the arrangement may be used in some low-demanding applications or environments as is where no additional strengthening or protection of the stator arrangement may be required. However, there may be some applications or environments which are sufficiently demanding so as to require that additional strengthening or protection be applied to the stator arrangement. FIGS. 19 and 20 illustrate two example methods for providing such additional strengthening and/or protection to the stator arrangements. More specifically, FIG. 19 illustrates a strengthening and/or protective sleeve 190 inserted (e.g., via a press) over the outside of the stator arrangement. Such sleeve 190 may be metal or some other suitable material which provides additional strength to the stator arrangement, or may be plastic, paper or some other suitable material which provides additional protection (e.g., electrical insulation, protection from water, chemical exposure). Once inserted onto the stator arrangement, such sleeve 190 may be additionally treated (e.g., pressed, heat-shrunk, etc.) to cause compression of the sleeve 190 (as shown by the FIG. 19 hollowed arrows) and thus compressively stress the stator arrangement. Alternatively, the sleeve 190 may simply be glued, welded, screwed, etc. so as to be rigidly attached to the stator arrangement.

FIG. 20 shows an alternative strengthening and/or protective arrangement, wherein a strengthening and/or protective material 200 may be wrapped onto the stator arrangement. Again, such protective material 200 may be metal or some other suitable material which provides additional strength to the stator arrangement, or may be plastic, paper or some other suitable material which provides additional protection (e.g., electrical insulation, protection from water, chemical exposure). The protective material 200 may be a single wrapped layer, or may be wrapped as multiple layers. Once wrapped onto the stator arrangement, such protective material 200 may be additionally treated (e.g., pressed, heatshrunk, etc.) to cause compression of the protective material and thus compressively stress the stator arrangement. Alternatively, the protective material 200 may simply be glued, welded, screwed, etc. so as to be rigidly attached to the stator arrangement.

At this point, it may be useful to note that the foregoing and following arrangements and assembly methods have the advantage that automating the manufacturing process is simple since the handling of each member is easily performed.

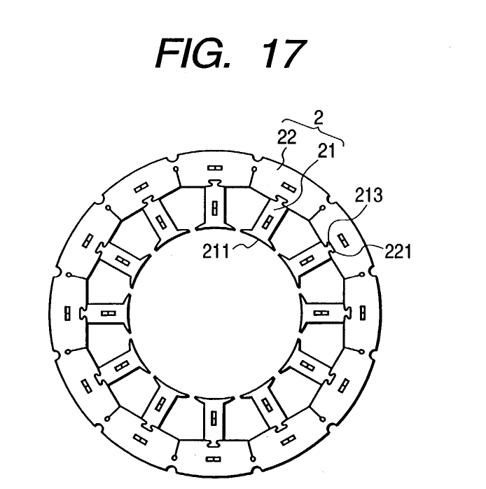

Discussion now continues with further alternative embodiments for different features/components of the invention. More particularly, while the above-discussed embodiments disclose an example embodiment wherein the teethed core portion 21 may be constructed via use of the FIG. 14a interconnected teeth strip 21a, embodiments of the present invention can also be practiced utilizing separated teeth 21 as shown, for example, in FIG. 17. Further, FIG. 28 shows a perspective view of one laminated tooth formed to a predetermined thickness Lₜ. With a separated teeth embodiment, after insertion of a coil mold piece 1 onto each tooth 21, a link or tongue 213 may be immediately aligned with a teeth link groove 221 so as facilitate mating of the same, and suitable pressure (e.g., via a press) may be used to press the loaded tooth portion 21 into the coreback 22. Thus, each individual tooth may be separated loaded with a coil and pressed into the coreback 22. Such separated teeth embodiment is advantageous in that loading of individual teeth is easier that loading of an entire teeth assembly, and also replacement of individual teeth 21 is facilitated. However, such separated teeth embodiment may be disadvantageous in that a mechanical strength thereof may be weaker than with the interconnected teethed core portion 21.

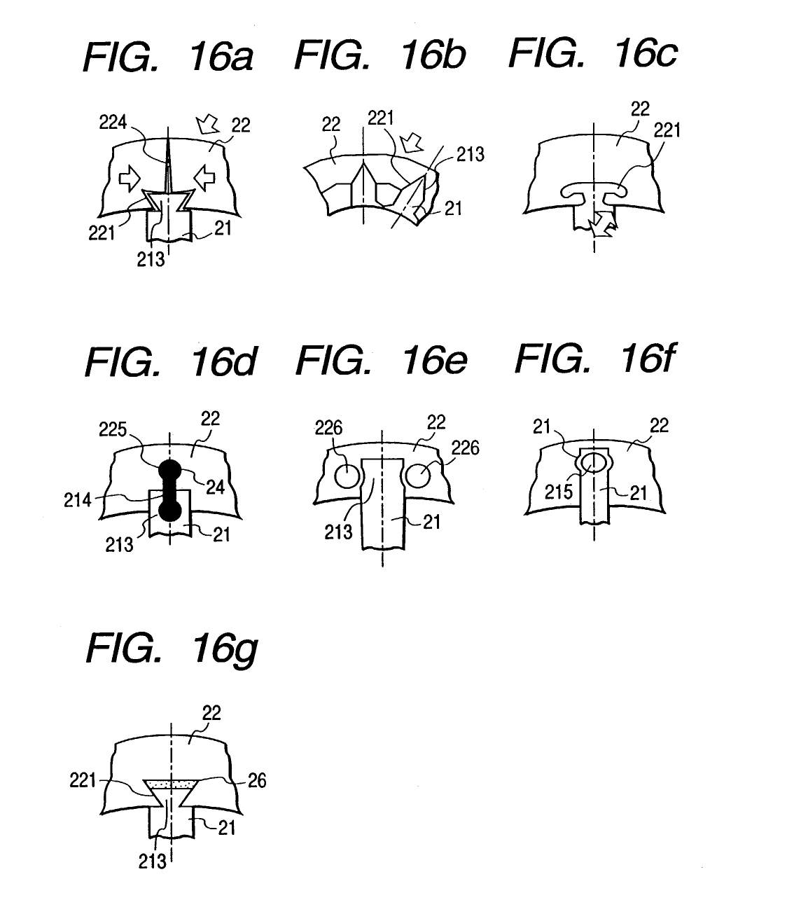

As further differing embodiments, the configuration of the link or tongue 213 and the teeth link groove 221 may also be changed. More specifically, FIG. 16a through FIG. 16g show a non-exhaustive examples of first through the seventh embodiments of the link/grooves for the teeth/coreback. These embodiments shows examples in which gaps possibly occurring between the link 213 of the teeth 21 and the groove 221 of the coreback 22 can be eliminated. In FIG. 16a, the link 213 and groove 221 have a triangular-like configuration, and further, a center notch 224 for bend molding of the core of the coreback 22 may be placed in alignment with the tooth 21. After initial assembly of the coil mold piece and teeth 21 into the core 2, the bend form section may be further compressed by press-fit of the core and/or a housing (e.g., FIGS. 19-20 sleeve 190 or wrap 200) in a structure that tightens the groove 221 and thus coupling of the coreback and teeth.

In FIG. 16b, the coreback 22 and teeth 21 may be joined with a taper-shaped link 213 and groove 221, and again, after initial assembly of the coil mold piece and core 2, the arrangement may be further compressed by press-fit of the core and/or a housing (e.g., FIGS. 19-20 sleeve 190 or wrap 200) in a structure that tightens the coupling of the coreback and teeth. In FIG. 16c, the link 21 of the coreback 22 has a long slot cut in a circular direction as shown in the Fig. This arrangement, by utilizing the spring effect of the core material, imparts a resilient deformation to the teeth link 221 during installation of the teeth 21 in a structure that retains a tightening force even after being joined.

In FIG. 16d, the coreback 22 and the teeth 21 are linked by way of another member 24 having enlarged rounded ends and an elongated central portion 214. Consequently, an axial notch 225 may be formed in the coreback 22, and an identical notch 215 may be also formed in the link 213 of the teeth 21. Once the teeth 21 and coreback 22 are aligned during manufacture, the member 24 may be then installed (e.g., via press fitting) to occupy the axial notches 215 and 225, so as to join the teeth 21 and coreback 22 In FIG. 16e and FIG. 16f, a coupling method called a ball expansion method may be utilized. In other words, in FIG. 16e, holes 226 are formed in the coreback 22 to enclose the link 213 of the teeth 21, or in FIG. 16f, a hole 215 may be cut in the link of the teeth 21. In each of these structures, a ball slightly larger than the hole, and a rod are passed through to expand the hole(s). The coreback 22 or the teeth 21 thus undergo plasticizing deformation and a coupling force is obtained. In another embodiment, the rod itself may be slightly larger than the hole, to itself expand the hole without use of the ball. In such an embodiment, the rod may be permanently left inside the hole so as to join together the laminated layers of the coreback 22 or teeth 21 and provide strengthening thereto.

In FIG. 16g, a shape for the teeth 21 and the coreback 22 can be triangular, and similar to the above-mentioned ball method, a so-called razor method can be used. More particularly, in the razor method, a wedge 26 may be punched into a structure between the link 213 and a slot 221 so as to tighten the joint therebetween. The wedge 26 itself may be slightly larger than the joint hole, to itself expand such joint hole upon insertion. In such an embodiment, the wedge 26 may be permanently left inside the hole so as to join together the laminated layers of the coreback 22 or teeth 21 and provide strengthening thereto.

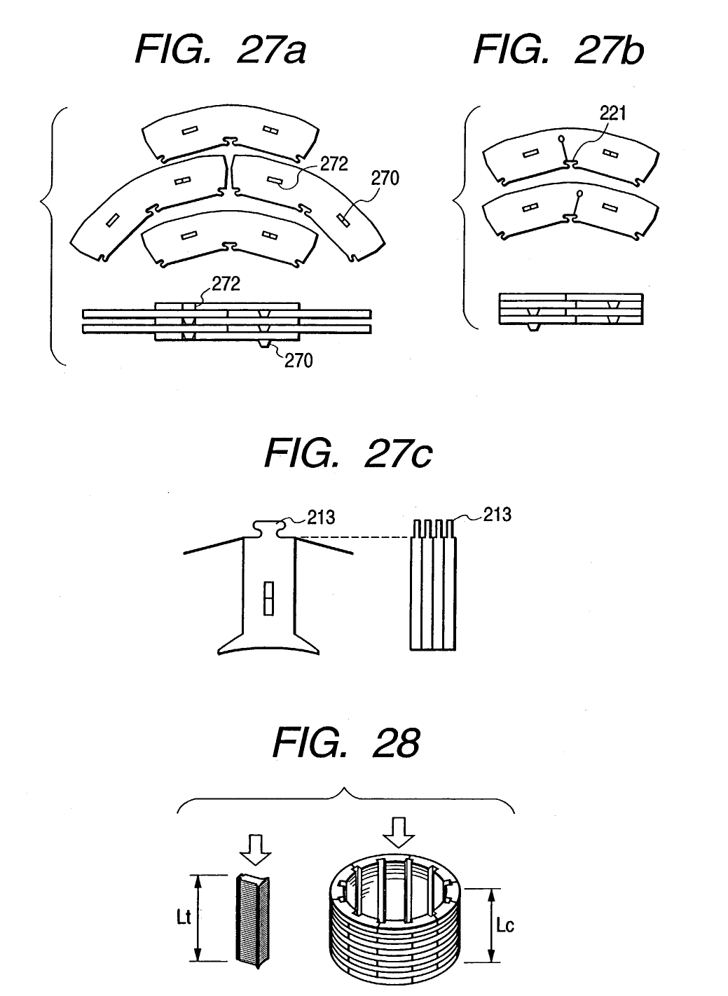

FIGS. 26a-26c and 27c show further example embodiments which may make it easier to insert (e.g., press fit) the links 213 into the teeth link grooves 221. More particularly, FIGS. 26a-26c show not only alternative link/groove arrangements, but also show accommodation splits 260 which are purposefully provided (e.g., via stamping, laser cutting) in the coreback strips. Such accommodation splits 260 allow the coreback strips to flex somewhat so as to allow entry of the links 213 into the grooves. Any number of accommodation splits 260 may be provided, e.g., FIGS. 26a-26b show example embodiments having a single accommodation split 260, whereas FIG. 26c shows and example embodiment having dual accommodation splits.

FIG. 27c shows a plan and edge view of an embodiment wherein the links 213 are of a reduced thickness in comparison to a remainder of the teeth from which the links 213 extend. Such reduced thickness links 213 are advantageous in that they flex somewhat so as to allow easier entry of the links 213 into the teeth link grooves 221. In addition reduced thicknesses, edges of the links 213 (or the teeth link grooves 221) may be further processed (e.g., rounded, beveled) via grinding, etching, laser trimming, etc., so as to improve entry of the links 213 into the teeth link grooves 221.

By utilizing a structure in which the coreback and teeth are coupled as shown in the above examples, an inter-teeth/coreback gap can be decreased as needed and insertion of the links can be improved. Accordingly, the vibration noise can be drastically reduced so that as a result, a stator core can be obtained in which adverse effects on service longevity, and part characteristics are reduced.

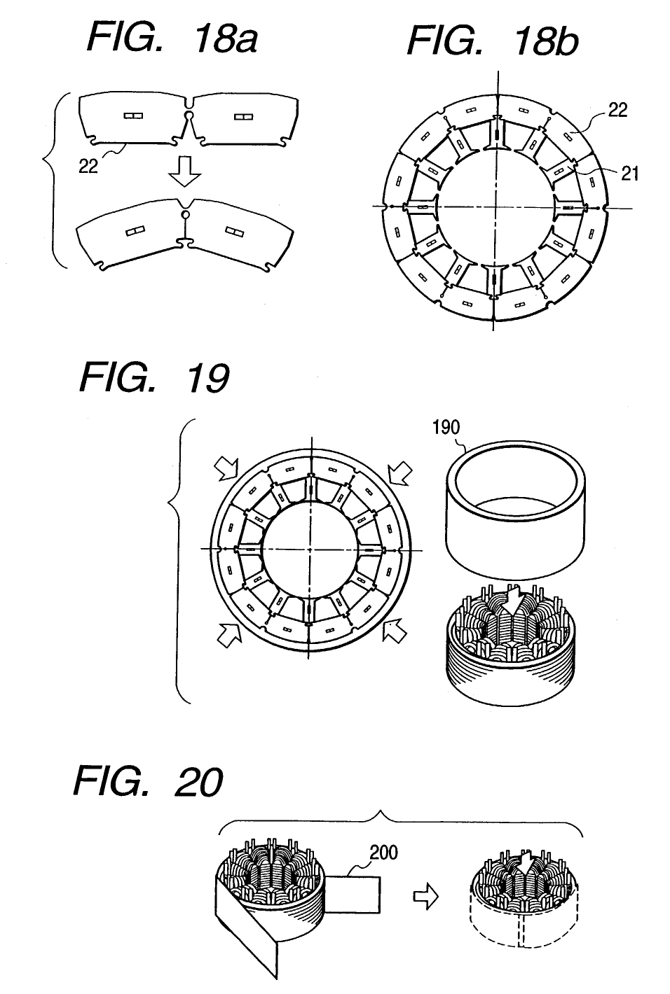

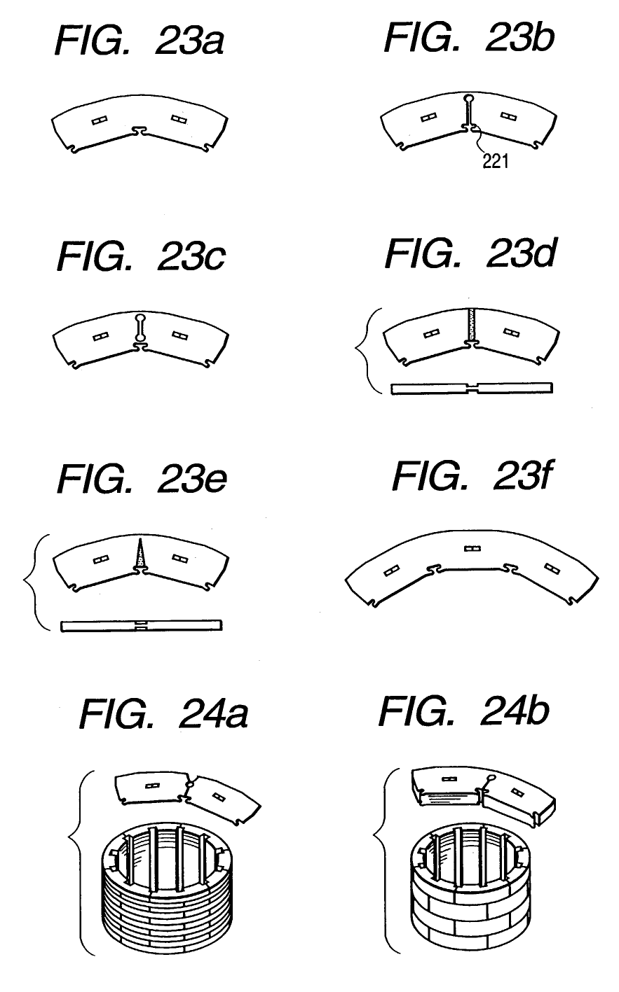

Variations may also be made from the FIG. 14b coreback strip 22a. More particularly, smaller strip lengths having a smaller number of coreback sectors 22s may alternatively be formed and used. As one example, FIG. 18ashows a sample coreback strip formed (e.g., via stamping, cutting) to have two coreback sectors, which are then appropriately bent to form an arc, e.g., of approximately 30°. FIG. 18b, in turn, shows a stator core (unloaded with coil mold pieces) constructed using the FIG. 18a two-sector coreback strips. With such arrangement, the FIG. 19 sleeve 190 may be used to provide additional strength thereto.

Whereas FIG. 18a shows an example coreback strip requiring bending, FIGS. 23a-24e show example two-sector coreback strips not requiring bending. More particularly, FIG. 23a shows a two-sector coreback strip without any central groove, while FIG. 25c shows a portion of a core constructed using such non-grooved coreback strip. FIG. 23b shows a two-sector coreback strip with a central groove extending from the teeth link groove 221, while FIGS. 25a-25b show a portion of a core constructed using such grooved coreback strip. FIG. 23c shows a two-sector coreback strip with a central groove which is not joined with the teeth link groove 221. The FIG. 23c central groove may be useful in the aforementioned rod embodiment, wherein a rod may be pressed and permanently left inside the hole so as to join together the laminated layers of the coreback 22 and provide strengthening thereto. FIG. 23d shows a plan and edge view of an embodiment wherein a straight-shaped stamping of reduced thickness (in comparison to a remainder of the coreback strip) extends from the teeth link groove 221, while FIG. 23e shows a plan and edge view of an embodiment wherein a V-shaped stamping of reduced thickness (in comparison to a remainder of the coreback strip) extends from the teeth link groove 221. Such reduced thickness stampings are advantageous in that they are able to absorb any required bending and/or compression of the coreback strip during the manufacturing process, and are further advantageous in that they provide increased strength to the coreback strip as no hole or material void is provided. FIG. 23f is illustrative of the fact that embodiments of the present invention are further not limited to the two-sector coreback strips, e.g., three or any other numbered sector coreback strips may be used.

FIG. 27b shows a two-sector coreback strip with an oblique groove extending from the teeth link groove 221. Such oblique groove embodiment is advantageous in that, if a predetermined plurality of the coreback strips are aligned and stacked directly on top of each other to construct a two-sector coreback block as shown in the upper portion of FIG. 24b, the oblique grooves can be alternated in opposing directions from layer-to-layer so as to distribute the grooves at different locations throughout the coreback block so as to strengthen the same. Additionally, if an oblique groove is overlapped over a straight joint between neighboring coreback strips, again such oblique groove will extend in a different direction from the straight joint, and thus strengthen the arrangement.

Several of the FIGS. are also illustrative of differing methods of using the coreback strips to construct the coreback. More particularly, as mentioned above, FIGS. 24b and 27b are illustrative of a method wherein a predetermined plurality of the coreback strips are aligned and stacked directly on top of each other to construct two-sector coreback blocks, and such blocks are then overlapped in a mis-aligned (i.e., brick-like) manner as shown in a lower portion of FIG. 24b to construct the coreback. Alternatively, FIGS. 24a and 27a are illustrative of a method wherein coreback blocks are not used, and instead two-sector coreback strips are individually used and mis-aligned from layer-to-layer such that the joints between neighboring coreback strips are distributed throughout the coreback so as to strengthen the same.

FIGS. 27a and 27b are further illustrative of one example method for providing alignment and/or attachment between overlapping coreback strips. More particularly, two differing types of alignment/attachment zones 270 and 272 are shown, and may be provided in an alternating fashion along the coreback strips. The alignment/attachment zone 270 represents a male-type alignment/attachment zone having a protrusion, whereas the alignment/attachment zone 272 represents a female-type alignment/attachment zone having a hole or depression. As coreback strips are mis-aligned from layer-to-layer (see FIGS. 27a and 27b) such that the joints between neighboring coreback strips are distributed from layer-to-layer so as to strengthen the constructed coreback, the male-type alignment/attachment zones 270 align and mate with the female-type alignment/attachment zones 272 so as to provide accurate alignment between the overlapping coreback strips.

In addition to alignment, arrangements/procedures may be provided to cause the laminated coreback sectors to become permanently attached to one another. For example, such alignment/attachment zones may be of such a design/arrangement that overlapping zones 270, 272 not only mate, but also interlock with each other. As another example, spot welding can be applied to the zones to weld the overlapping layers together. As another example, the zones may be caulked (i.e., plastically deformed) to interlock together.

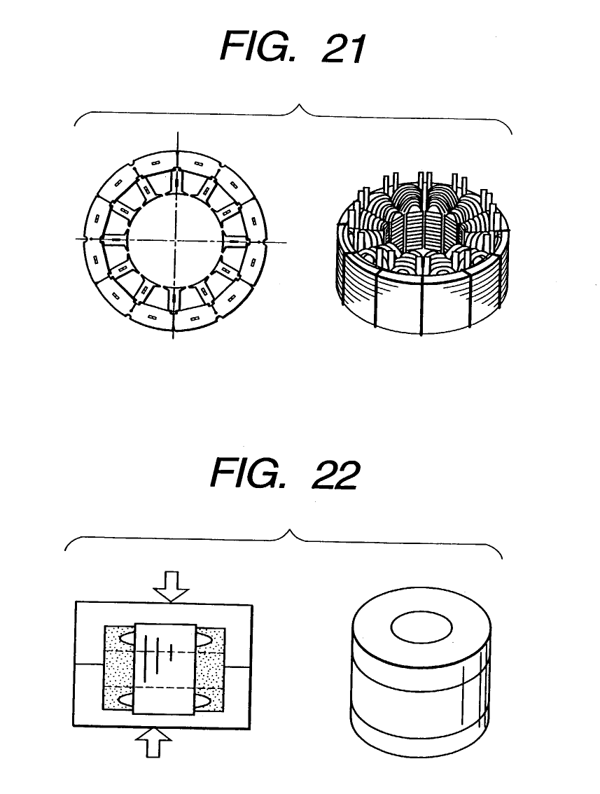

In addition to the above, a less advantageous embodiment may be constructed using singular coreback sectors as illustrated in the FIG. 21 plan and perspective views. However, manufacturing is more difficult with the separate singular coreback sectors, and in order to add rigidity/stability to such embodiment, the constructed arrangement may be further processed (e.g., pressurized, welded, etc.) as shown in the left-hand drawing of FIG. 22, or may receive both a protective sleeve and endcaps as shown in the right-hand drawing of FIG. 22.

In this invention the cross-section dimensional precision is increased and the space factor improved by changing the cross-sectional shape of the coil. These factors in turn yield improved efficiency in the rotating machine. This improved efficiency with a smaller core allow the body of the rotating machine itself to be made more compact and a smaller machine makes it possible to reduce expenses for materials. Further, a drastic reduction in material costs is also possible since the utilization rate of the material has been improved. As a result, the rotating machines and in particular electrical motors which are key components in combination equipment sets, allow those combination equipment sets which include motors, to be made more compact, lighter in weight and less expensive.

Further, in this invention as explained above, a cross-sectional coil shape is formed after winding the coil and the precision of each coil's cross-sectional dimensions increased by altering the cross-sectional shape during winding and improving the rotating machine space factor by effective use of the limited dimensions of the slot cross-section. The device efficiency, compactness and ease of assembly is also improved when the space factor of the rotation machine has been improved. Further, along with splitting up the teeth of the core and the coreback, forming the respective contours of the teeth and coreback in a belt shape enables the iron core material to be utilized with high efficiency.

This concludes the description of the preferred embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A coil mold piece adapted for use in a rotating electric machine, wherein said coil mold piece is compacted-shaped such that a substantial majority of wire windings are plastically deformed to minimize spacings between said wire windings, and such that at least one predetermined cross-section across said coil mold piece has a predetermined wedge shape.

2. A coil mold piece as claimed in claim 1, wherein said coil mold piece is adapted to have a through-hole to facilitate mounting of said coil mold piece onto a core tooth and within a core slot of said rotating electric machine, wherein a side surface of said wedge shape is adapted to be stored in said slot and spread out in a fan-shape from one end of said through-hole towards another end, and said one end being adapted to adjoin a tip of said tooth, and said another end being adapted to adjoin a coreback of said rotating electric machine.

3. A coil mold piece as claimed in claim 1, wherein said coil mold piece is compacted-shaped into said predetermined wedge shape by at least one of a press mold apparatus and a stamper apparatus.

4. A coil mold piece as claimed in claim 1, wherein said one end being adapted to adjoin said tip of said tooth is formed at an angle which is oblique to an central axis of said through-hole.

5. A coil mold piece as claimed in claim 1, wherein with a diameter of a wire material of said coil mold piece being given as d, with windings aligned radially along a coil mold piece being given as m, with a number of wire layers aligned tangentially across a coil mold piece being given as n, and with said wire material well aligned in said slot, a surface area S₀ for a particular cross-section of said coil mold piece is expressed as:
S₀={d+\sqrt{3}·d/2·(n−1)}·(d·m)
so that the cross-sectional area Sp for the portion stored in said slot for a cross-section of the same section is Sₚ<S₀.

6. A stator adapted for use in a rotating electric machine, said stator comprising:
a core; and
at least one coil mold piece, wherein said coil mold piece is compacted-shaped such that a substantial majority of wire windings are plastically deformed to minimize spacings between said wire windings, and such that at least one predetermined cross-section across said coil mold piece has a predetermined wedge shape.

7. A stator as claimed in claim 6:
wherein said core comprises a coreback, at least one core tooth and a core slot; and
wherein said at least one coil mold piece has a through-hole mounting said coil mold piece onto said at least one core tooth, and being mounted within said core slot, wherein a side surface of said wedge shape is stored in said core slot and spread out in a fan-shape from one end of said through-hole towards another end, and said one end adjoining a tip of said at least one tooth, and said another end adjoining said coreback.

8. A stator as claimed in claim 6, wherein said coil mold piece is compacted-shaped into said predetermined wedge shape by at least one of a press mold apparatus and a stamper apparatus.

9. A stator as claimed in claim 6, wherein said one end adjoining said tip of said core tooth is formed at an angle which is oblique to an central axis of said through-hole.

10. A stator as claimed in claim 6, wherein with a diameter of a wire material of said coil mold piece being given as d, with windings aligned radially along a coil mold piece being given as m, with a number of wire layers aligned tangentially across a coil mold piece being given as n, and with said wire material well aligned in said slot, a surface area S₀ for a particular cross-section of said coil mold piece is expressed as:
S₀={d+\sqrt{3}·d/2·(n−1)}·(d·m)
so that the cross-sectional area Sₚ for the portion stored in said slot for a cross-section of the same section is Sₚ<S₀.

11. A stator as claimed in claim 7;
wherein said coreback is constructed of a plurality of multiple-sector coreback strips laminated together;
wherein said core includes a predetermined plurality of core teeth, and said teeth are provided as one of: individual teeth of a laminated construction; and, linked teeth of a laminated construction; and
wherein said coreback and said teeth interconnect using a predetermined interconnection arrangement.

12. A stator as claimed in claim 11, wherein said at least one coil mold piece is adapted to be mounted onto said teeth before interconnection of said coreback and said teeth.

13. A stator as claimed in claim 11;
wherein said predetermined plurality of core teeth are linked teeth of a laminated construction; and
wherein said multiple-sector coreback strips and said linked teeth are at least one of stamped and cut from a strip-like metal stock.

14. A method of manufacturing a coil mold piece adapted for use in a rotating electric machine, said method comprising compact-shaping said coil mold piece such that a substantial majority of wire windings are plastically deformed to minimize spacings between said wire windings, and such that at least one predetermined cross-section across said coil mold piece has a predetermined wedge shape.

15. A method as claimed in claim 14, wherein said coil mold piece is adapted to have a through-hole to facilitate mounting of said coil mold piece onto a core tooth and within a core slot of said rotating electric machine, wherein a side surface of said wedge shape is adapted to be stored in said slot and spread out in a fan-shape from one end of said through-hole towards another end, and said one end being adapted to adjoin a tip of said tooth, and said another end being adapted to adjoin a coreback of said rotating electric machine.

16. A method as claimed in claim 14, wherein said coil mold piece is compacted-shaped into said predetermined wedge shape by at least one of a press mold apparatus and a stamper apparatus.

17. A method as claimed in claim 14, wherein said one end being adapted to adjoin said tip of said tooth is formed at an angle which is oblique to an central axis of said through-hole.

18. A method as claimed in claim 14, wherein with a diameter of a wire material of said coil mold piece being given as d, with windings aligned radially along a coil mold piece being given as m, with a number of wire layers aligned tangentially across a coil mold piece being given as n, and with said wire material well aligned in said slot, a surface area S₀ for a particular cross-section of said coil mold piece is formed in such a manner so as to expressed as:
S₀={d+\sqrt{3}·d/2·(n−1)}·(d·m)
so that the cross-sectional area Sₚ for the portion stored in said slot for a cross-section of the same section is Sₚ<S₀.

19. A method of manufacturing a stator adapted for use in a rotating electric machine, said method comprising;
forming a stator comprising a core; and
compact-shaping at least one coil mold piece such that a substantial majority of wire windings are plastically deformed to minimize spacings between said wire windings, and such that at least one predetermined cross-section across said coil mold piece has a predetermined wedge shape.

20. A method as claimed in claim 19:
wherein said core comprises a coreback, at least one core tooth and a core slot; and
wherein said at least one coil mold piece has a through-hole;
and further comprising mounting said coil mold piece onto said at least one core tooth and within said core slot, wherein a side surface of said wedge shape is stored in said core slot and spread out in a fan-shape from one end of said through-hole towards another end, and said one end adjoining a tip of said at least one tooth, and said another end adjoining said coreback.

21. A method as claimed in claim 19, wherein said coil mold piece is compacted-shaped into said predetermined wedge shape by at least one of a press mold apparatus and a stamper apparatus.

22. A method as claimed in claim 19, wherein said one end adjoining said tip of said core tooth is formed at an angle which is oblique to an central axis of said through-hole.

23. A method as claimed in claim 19, wherein with a diameter of a wire material of said coil mold piece being given as d, with windings aligned radially along a coil mold piece being given as m, with a number of wire layers aligned tangentially across a coil mold piece being given as n, and with said wire material well aligned in said slot, said coil mold piece is formed such that a surface area S₀ for a particular cross-section of said coil mold piece is expressed as:
S₀={d+\sqrt{3}·d/2·(n−1)}·(d·m)
so that the cross-sectional area Sₚ for the portion stored in said slot for a cross-section of the same section is Sₚ<S₀.

24. A method as claimed in claim 20;
wherein said coreback is constructed of a plurality of multiple-sector coreback strips laminated together;
wherein said core includes a predetermined plurality of core teeth, and said teeth are provided as one of: individual teeth of a laminated construction; and, linked teeth of a laminated construction; and
further comprising interconnecting said coreback and said teeth using a predetermined interconnection arrangement.

25. A method as claimed in claim 24, wherein said at least one coil mold piece is mounted onto said teeth before interconnecting of said coreback and said teeth.

26. A method as claimed in claim 24;
wherein said predetermined plurality of core teeth are linked teeth of a laminated construction; and
wherein said multiple-sector coreback strips and said linked teeth are at least one of stamped and cut from a strip-like metal stock.
